(19) United States
(12) Patent Application Publication
(10) Pub. No.: US 2026/0204760 A1
(43) Pub. Date: Jul. 16, 2026

(54) SECONDARY BATTERY AND ELECTRONIC APPARATUS

(71) Applicant: NINGDE AMPEREX TECHNOLOGY LIMITED, Ningde (CN)

(72) Inventors: Jinli WANG, Ningde (CN); Chen WANG, Ningde (CN); Dongyang YAN, Ningde (CN)

(73) Assignee: NINGDE AMPEREX TECHNOLOGY LIMITED, Ningde (CN)

(21) Appl. No.: 19/559,454

(22) Filed: Mar. 6, 2026

Related U.S. Application Data
(63) Continuation of application No. PCT/CN2024/109246, filed on Aug. 1, 2024.

(30) Foreign Application Priority Data
Sep. 7, 2023 (CN) 202311150807.9

(51) Int. Cl. H01M 50/595; H01M 4/66; H01M 10/0569; H01M 50/105; H01M 50/178; H01M 50/586

(52) U.S. Cl. CPC H01M 50/595; H01M 4/667; H01M 4/668; H01M 10/0569; H01M 50/105; H01M 50/178; H01M 50/586; H01M 2300/0037

(57) ABSTRACT

A positive electrode sheet in the secondary battery includes a positive electrode current collector, a positive electrode active material layer, and a positive electrode tab, where the positive electrode active material layer is disposed on at least one surface of the positive electrode current collector. The positive electrode active material layer is provided with a first groove exposing the positive electrode current collector. The positive electrode tab is disposed in the first groove and connected to the positive electrode current collector. An insulating tape is provided on each of a surface of the positive electrode tab and a region, corresponding to the first groove, of a surface of the positive electrode sheet away from the positive electrode tab. A melting point of the insulating tape is 250° C. to 450° C. An electrolyte includes carbonate and carboxylate.

### CROSS REFERENCE TO THE RELATED APPLICATIONS

This application is a continuation under 35 U.S.C. § 120 of international patent application PCT/CN2024/109246 filed on Aug. 1, 2024, which claims priority to Chinese Patent Application No. 202311150807.9, filed with the China National Intellectual Property Administration on Sep. 7, 2023 and entitled “SECONDARY BATTERY AND ELECTRONIC APPARATUS”, which is incorporated herein by reference in its entirety.

### TECHNICAL FIELD

This application relates to the field of electrochemical technology, and in particular, to a secondary battery and an electronic apparatus.

### BACKGROUND

A secondary battery typically includes a positive electrode sheet, a negative electrode sheet, a separator, an electrolyte, and a packaging bag. Due to the advantages such as high energy density, high power density, light weight, small volume, and long cycle life, the secondary battery has been widely used in consumer electronics (3C) products. However, under extreme environmental conditions, the secondary battery may pose risks of fire and explosion, threatening the personal safety of consumers. Therefore, ensuring the reliability of the secondary battery is particularly important. Among the reliability tests, the high-temperature short-circuit test is a critical item. When an external short circuit occurs, excessive heat generation may cause a rapid increase in the temperature of the secondary battery, leading to local short circuits and causing safety issues. Therefore, how the high-temperature short-circuit pass rate of the secondary battery is increased to improve the reliability of the secondary battery has become an urgent technical problem for those skilled in the art to address.

### SUMMARY

This application is intended to provide a secondary battery and an electronic apparatus to improve the reliability of the secondary battery.

It should be noted that in the summary of this application, a lithium-ion battery is used as an example of a secondary battery to explain this application, but the secondary battery of this application is not limited to the lithium-ion battery. The specific technical solutions are described below.

A first aspect of this application provides a secondary battery. The secondary battery includes an electrode assembly and an electrolyte, where the electrode assembly includes a positive electrode sheet, a negative electrode sheet, and a separator disposed between the positive electrode sheet and the negative electrode sheet; the positive electrode sheet includes a positive electrode current collector, a positive electrode active material layer, and a positive electrode tab; the positive electrode active material layer is disposed on at least one surface of the positive electrode current collector; the positive electrode active material layer is provided with a first groove exposing the positive electrode current collector; the positive electrode tab is disposed in the first groove and connected to the positive electrode current collector; an insulating tape is provided on each of a surface of the positive electrode tab and a region, corresponding to the first groove, of a surface of the positive electrode sheet away from the positive electrode tab; a melting point of the insulating tape is 250° C. to 450° C.; the electrolyte includes carbonate and carboxylate; and based on a mass of the electrolyte, a mass percentage of the carbonate is denoted as A and a mass percentage of the carboxylate is denoted as B, where A and B satisfy: 75%≤A+B≤88% and 1<A/B. In this application, the insulating tape within the melting point range of this application is provided on each of the surface of the positive electrode tab and the region, corresponding to the first groove, of the surface of the positive electrode sheet away from the positive electrode tab, and the total content of carbonate and carboxylate in the electrolyte and the content ratio A/B of carbonate and carboxylate are controlled within the above range, so that during a high-temperature short-circuit test, when an internal temperature of the secondary battery rises rapidly and a large amount of heat is generated in the secondary battery, the insulating tape exhibits good high-temperature stability and low thermal shrinkage rate and can maintain its integrity as applied, providing effective protection to the positive electrode tab, and reducing the probability of the positive electrode tab coming into contact with the negative electrode sheet after exposed and causing a short circuit. The electrolyte exhibits good stability at high temperatures, few side reactions, and a small gas production amount, reducing the risk of deformation of the secondary battery and allowing the positive and negative electrode sheets to maintain their original relative positions, thereby reducing the risk of an internal short circuit caused by contact between the positive and negative electrode sheets. Thus, the insulating tape and the electrolyte work synergistically to increase a high-temperature short-circuit pass rate of the secondary battery, thereby improving the reliability of the secondary battery.

In an embodiment of this application, the melting point of the insulating tape is 250° C. to 400° C. Controlling the melting point of the insulating tape within the above range can reduce the production cost of the secondary battery while increasing the high-temperature short-circuit pass rate of the secondary battery.

In an embodiment of this application, the negative electrode sheet includes a negative electrode current collector, a negative electrode active material layer, and a negative electrode tab, where the negative electrode active material layer is disposed on at least one surface of the negative electrode current collector; the negative electrode active material layer is provided with a second groove exposing the negative electrode current collector; the negative electrode tab is disposed in the second groove and connected to the negative electrode current collector; a tab protection tape is provided on a region, corresponding to the second groove, of a surface of the negative electrode sheet away from the negative electrode tab; and the insulating tape is provided on each of a region of a surface of the positive electrode sheet opposite to the second groove and a region of the surface of the positive electrode sheet opposite to the tab protection tape. The insulating tape is provided on each of the region of the surface of the positive electrode sheet opposite to the second groove and the region of the surface of the positive electrode sheet opposite to the tab protection tape, so that the risk of an internal short circuit in the secondary battery at high temperatures can be further reduced.

In an embodiment of this application, the insulating tape includes a substrate and an adhesive layer disposed on one surface of the substrate, where the substrate includes at least one of polyethylene terephthalate, polyethylene, polytetrafluoroethylene, polyvinyl chloride, polyimide, or polypropylene. The substrates of the above types have high melting points and good thermal stability, and selecting such substrates is conducive to increasing the high-temperature short-circuit pass rate of the secondary battery.

In an embodiment of this application, along a length direction of the positive electrode sheet, a length of the insulating tape provided on the surface of the positive electrode tab is 3 to 4 times a width of the positive electrode tab; and along a width direction of the positive electrode sheet, a width of the insulating tape provided on the surface of the positive electrode tab is 0.25 to 0.4 times a width of the positive electrode sheet. Controlling the length and width of the insulating tape covering the positive electrode tab within the above ranges is conducive to improving a coverage effect of the insulating tape on the positive electrode tab, thereby increasing the high-temperature short-circuit pass rate of the secondary battery.

In an embodiment of this application, along a length direction and width direction of the insulating tape, thermal shrinkage rates of the insulating tape at a temperature of 300° C. are both less than or equal to 1%. This indicates that the insulating tape has good high-temperature stability at the temperature of 300° C.

In an embodiment of this application, the carbonate includes at least one of ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and the carboxylate includes at least one of ethyl acetate, propyl propionate, butyl acetate, ethyl propionate, propyl acetate, or butyl propionate.

In an embodiment of this application, the carbonate includes at least one of ethylene carbonate, propylene carbonate, or diethyl carbonate; the carboxylate includes at least one of propyl acetate or propyl propionate; and 75%≤A+B≤88% and 2%≤A−B≤5%. Selecting the above types of carbonates and carboxylates and controlling the total mass A+B of the carbonate and the carboxylate in the electrolyte and the content difference A−B within the above ranges can further reduce the probability of explosion due to a large gas production amount inside the secondary battery, thereby further improving the reliability of the secondary battery.

In an embodiment of this application, the secondary battery includes a packaging bag; the electrode assembly and the electrolyte are accommodated in the packaging bag; the positive electrode tab and the negative electrode tab extend from the packaging bag; the positive electrode tab and the negative electrode tab are each provided with a sealing adhesive, where the sealing adhesive is sealingly connected to the packaging bag; and a melting point of the sealing adhesive is 130° C. to 150° C. Controlling the melting point of the sealing adhesive within the above range is conducive to further improving the reliability of the secondary battery.

In an embodiment of this application, the sealing adhesive includes at least one of polypropylene, polyethylene, polyethylene terephthalate, or polyethylene naphthalate.

A second aspect of this application provides an electronic apparatus including the secondary battery according to any one of the foregoing embodiments. Therefore, the electronic apparatus has good reliability.

The beneficial effects of this application are described below.

This application provides a secondary battery and an electronic apparatus. The secondary battery is provided with an insulating tape within a melting point range of this application on each of a surface of a positive electrode tab and a region, corresponding to a first groove, of a surface of a positive electrode sheet away from the positive electrode tab, and a total content of carbonate and carboxylate in the electrolyte and a content ratio A/B of carbonate and carboxylate are controlled within the above range, so that during a high-temperature short-circuit test, when an internal temperature of the secondary battery rises rapidly and a large amount of heat is generated in the secondary battery, the insulating tape exhibits good high-temperature stability and low thermal shrinkage rate and can maintain its integrity as applied, providing effective protection to the positive electrode tab, and reducing the probability of the positive electrode tab coming into contact with the negative electrode sheet after exposed and causing a short circuit. The electrolyte exhibits good stability at high temperatures, few side reactions, and small gas production amount, reducing the risk of deformation of the secondary battery and allowing electrode sheets to maintain their original relative positions, thereby reducing the risk of an internal short circuit caused by contact between positive and negative electrode sheets. Thus, the insulating tape and the electrolyte work synergistically to increase a high-temperature short-circuit pass rate of the secondary battery, thereby improving the reliability of the secondary battery.

Certainly, any product or method implementing this application does not necessarily need to achieve all the advantages described above simultaneously.

### BRIEF DESCRIPTION OF THE DRAWINGS

To more clearly illustrate the technical solutions in some embodiments of this application or in the prior art, the drawings required for describing these embodiments or the prior art are briefly described below. Apparently, the drawings described below are only some embodiments of this application, and those of ordinary skill in the art can obtain other embodiments based on these drawings.

FIG. 1 is a schematic diagram of an adhesion position of an insulating tape according to an embodiment of this application;

FIG. 2 is a schematic diagram of an adhesion position of an insulating tape on a surface of a positive electrode tab according to an embodiment of this application;

FIG. 3 is a schematic diagram of an adhesion position of the insulating tape in FIG. 2 in a region, corresponding to a first groove, of a surface of a positive electrode current collector away from the positive electrode tab; and

FIG. 4 is a schematic diagram of an adhesion position of an insulating tape according to another embodiment of this application.

### DETAILED DESCRIPTION

The technical solutions in some embodiments of this application will be clearly and completely described below in conjunction with the drawings in these embodiments of this application. Apparently, the described embodiments are only some rather than all of these embodiments of this application. All other embodiments obtained by those skilled in the art based on this application fall within the protection scope of this application.

It should be noted that in the specific embodiments of this application, a lithium-ion battery is used as an example of a secondary battery to explain this application, but the secondary battery of this application is not limited to the lithium-ion battery.

When a secondary battery generates an excessively high amount of heat during abuse and is at a high temperature (which is a temperature greater than or equal to 150° C.), a separator is prone to shrinking, easily causing contact between a positive electrode sheet and a negative electrode sheet, and thus resulting in an internal short circuit. A temperature at a positive electrode tab, especially an aluminum tab, is often the highest, causing a tab protection tape and an exposed sealing adhesive to melt, thus leading to contact between the positive electrode tab at a welding point and a large area of the negative electrode sheet, and expanding an area of an internal short circuit in the secondary battery. Meanwhile, side reactions of an electrolyte at high temperatures are intensified, generating a large amount of gas. The movement of gas inside the secondary battery may cause separation of the positive electrode sheet, the separator, and the negative electrode sheet, making lithium ions unable to intercalate and deintercalate normally during charging and discharging of the secondary battery, resulting in capacity loss, or causing a short circuit between the positive and negative electrode sheets, thus causing fire and leading to an explosion of the secondary battery. Furthermore, the gas cannot be released in time, causing combustion and explosion of the secondary battery. Based on this, this application provides a secondary battery and an electronic apparatus.

A first aspect of this application provides a secondary battery. The secondary battery includes an electrode assembly and an electrolyte, where the electrode assembly includes a positive electrode sheet, a negative electrode sheet, and a separator disposed between the positive electrode sheet and the negative electrode sheet. The positive electrode sheet includes a positive electrode current collector, a positive electrode active material layer, and a positive electrode tab, where the positive electrode active material layer is disposed on at least one surface of the positive electrode current collector, and the positive electrode active material layer is provided with a first groove exposing the positive electrode current collector. The positive electrode tab is disposed in the first groove and connected to the positive electrode current collector. An insulating tape is provided on each of a surface of the positive electrode tab and a region, corresponding to the first groove, of a surface of the positive electrode sheet away from the positive electrode tab. A melting point of the insulating tape is 250° C. to 450° C. The electrolyte includes carbonate and carboxylate. Based on a mass of the electrolyte, a mass percentage of the carbonate is denoted as A and a mass percentage of the carboxylate is denoted as B, where A and B satisfy: 75%≤A+B≤88% and 1<A/B.

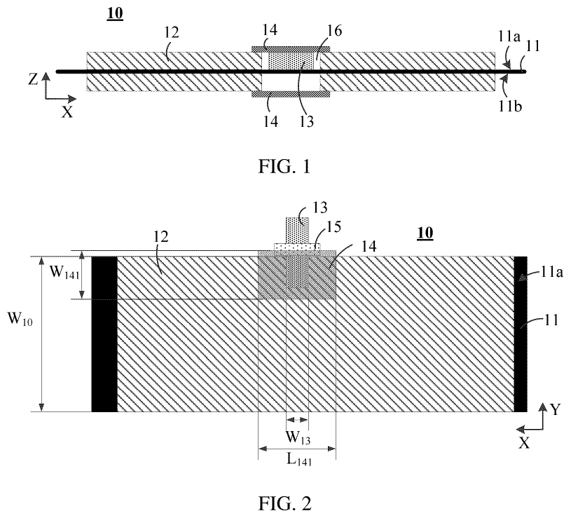

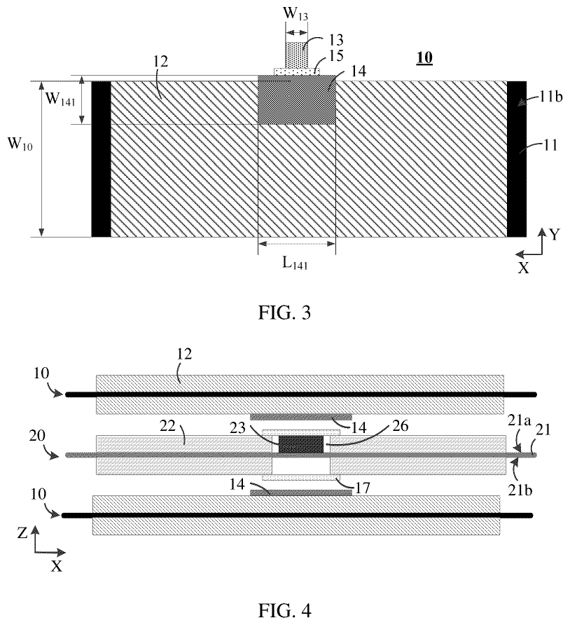

As shown in FIGS. 1 to 4, for ease of understanding, a three-dimensional rectangular coordinate system is established with a length direction of the positive electrode sheet 10 as a direction X, a width direction of the positive electrode sheet 10 as a direction Y, and a thickness direction of the positive electrode sheet 10 as a direction Z. It can be understood that length directions, width directions, and thickness directions of the positive electrode current collector 11, the positive electrode active material layer 12, the negative electrode sheet 20, and the separator are the same as those of the positive electrode sheet. “The positive electrode active material layer is disposed on at least one surface of the positive electrode current collector” means that the positive electrode active material layer is disposed on one surface or both surfaces of the positive electrode current collector, where the “surface” may be a partial surface of the positive electrode current collector or an entire surface of the positive electrode current collector. For example, in some embodiments, as shown in FIG. 1, the positive electrode current collector 11 includes a first surface 11a and a second surface 11b. The positive electrode active material layer 12 is disposed on both surfaces of the positive electrode current collector 11 that are the first surface 11a and the second surface 11b. In some other embodiments, the positive electrode active material layer 12 is disposed on one surface of the positive electrode current collector 11 that may be the first surface 11a or the second surface 11b. As shown in FIGS. 1 and 2, the positive electrode active material layer 12 is provided with a first groove 16 exposing the positive electrode current collector 11. The positive electrode tab 13 is disposed in the first groove 16 and connected to the positive electrode current collector 11. The positive electrode tab 13 is connected to the first surface 11a of the positive electrode current collector 11. A surface of the positive electrode tab 13 is provided with an insulating tape 14. As shown in FIGS. 1 and 3, the insulating tape 14 is provided on a region, corresponding to the first groove 16, of a surface of the positive electrode sheet 10 away from the positive electrode tab 13.

For example, the melting point of the insulating tape may be 250° C., 300° C., 350° C., 400° C., 450° C., or any value within a range defined by any two of the above values. When the melting point of the insulating tape is less than 250° C., the melting point is excessively low. When a large amount of heat is generated in the secondary battery, the insulating tape is prone to thermal shrinkage, reducing the probability of maintaining its integrity as applied, causing the insulating tape to detach from the surface of the positive electrode tab, and making the positive electrode tab prone to exposure and come into contact with the negative electrode sheet, thus expanding an area of an internal short circuit in the secondary battery, leading to a short circuit in the secondary battery, and increasing the probability of safety risks at an electrode tab. An insulating tape with a melting point greater than 450° C. is difficult to produce and has a high cost, which increases the production cost of the secondary battery and is not conducive to large-scale industrial production.

For example, the value of A+B may be 75%, 76%, 78%, 80%, 82%, 84%, 86%, 88%, or any value within a range defined by any two of the above values. For example, the value of A/B may be 1.01, 1.05, 1.1, 1.15, 1.2, 1.25, 1.3, 1.35, 1.4, 1.45, 1.49, or any value within a range defined by any two of the above values. When the value of a total content A+B of carbonate and carboxylate in the electrolyte is greater than 88%, contents of a lithium salt and an additive in the electrolyte are excessively low, and the insufficient lithium salt content affects the charging and discharging performance of the secondary battery. The insufficient additive content makes it difficult for the additive to exert its effect, affecting the performance of the secondary battery related to the additive. With a film-forming additive as an example, during an initial charge-discharge cycle, the film-forming additive is decomposed before carbonate and carboxylate are decomposed in the electrolyte, forming a stable solid electrolyte interface film on a surface of the negative electrode sheet, thereby protecting the electrode from damage by carbonate and carboxylate, and improving the lifespan and safety performance of the secondary battery. An excessively low content of the film-forming additive affects the lifespan and safety performance of the secondary battery. When the total content A+B of carbonate and carboxylate in the electrolyte is less than 75%, the ability to dissolve lithium salt is limited, reducing the number of lithium ions available for the charging and discharging processes of the secondary battery, thus affecting the charging and discharging performance and cycle life of the secondary battery. Carbonate has good stability at high temperatures with a small gas production amount. Carboxylate has low viscosity, facilitating transport of lithium ions, and making the electrolyte have high kinetic performance. When the value of A/B is less than or equal to 1, the relative content of carbonate in the solvent is excessively low, affecting the high-temperature stability of the electrolyte, which is not conducive to reducing the gas production amount of the electrolyte at high temperatures, thereby increasing the risk of explosion due to the increased gas production amount in the secondary battery.

In this application, the insulating tape within the melting point range of this application is provided on each of the surface of the positive electrode tab and the region, corresponding to the first groove, of the surface of the positive electrode sheet away from the positive electrode tab, and the total content of carbonate and carboxylate in the electrolyte and the content ratio A/B of carbonate and carboxylate are controlled within the above ranges, so that during a high-temperature short-circuit test, when an internal temperature of the secondary battery rises rapidly and a large amount of heat is generated in the secondary battery, the insulating tape exhibits good high-temperature stability and low thermal shrinkage rate and can maintain its integrity as applied, providing effective protection to the positive electrode tab, and reducing the probability of the positive electrode tab coming into contact with the negative electrode sheet after exposed and causing a short circuit. The electrolyte exhibits good stability at high temperatures, few side reactions, and a small gas production amount, reducing the risk of deformation of the secondary battery and allowing the electrode sheets to maintain their original relative positions, thereby reducing the risk of an internal short circuit caused by contact between the positive and negative electrode sheets. Thus, the insulating tape and the electrolyte work synergistically to increase a high-temperature short-circuit pass rate of the secondary battery, thereby improving the reliability of the secondary battery.

In an embodiment of this application, the melting point of the insulating tape is 250° C. to 400° C. For example, the melting point of the insulating tape may be 250° C., 300° C., 350° C., 400° C., or any value within a range defined by any two of the above values. The insulating tape with the melting point within the above range is produced more easily. Controlling the melting point of the insulating tape within the above range can reduce the production cost of the secondary battery while increasing the high-temperature short-circuit pass rate of the secondary battery.

In an embodiment of this application, the positive electrode tab includes either an aluminum tab or an aluminum alloy tab.

In an embodiment of this application, the negative electrode sheet includes a negative electrode current collector, a negative electrode active material layer, and a negative electrode tab, where the negative electrode active material layer is disposed on at least one surface of the negative electrode current collector. “The negative electrode active material layer is disposed on at least one surface of the negative electrode current collector” means that the negative electrode active material layer is disposed on one surface or both surfaces of the negative electrode current collector, where the “surface” may be a partial surface of the negative electrode current collector or an entire surface of the negative electrode current collector. The negative electrode active material layer is provided with a second groove exposing the negative electrode current collector. The negative electrode tab is disposed in the second groove and connected to the negative electrode current collector. A tab protection tape is provided on a region, corresponding to the second groove, of a surface of the negative electrode sheet away from the negative electrode tab. The insulating tape is provided on each of a region of a surface of the positive electrode sheet opposite to the second groove and a region of the surface of the positive electrode sheet opposite to the tab protection tape. It should be noted that the positive electrode sheet in the “region of the surface of the positive electrode sheet opposite to the second groove” and the positive electrode sheet in the “region of the surface of the positive electrode sheet opposite to the tab protection tape” are not the same layer of positive electrode sheets, but are two layers of positive electrode sheets respectively adjacent to the negative electrode sheet. The “two layers of positive electrode sheets” may be two positive electrode sheets or two layers formed by winding one positive electrode sheet. As shown in FIG. 4, the negative electrode sheet 20 includes a negative electrode current collector 21, a negative electrode active material layer 22, and a negative electrode tab 23, where the negative electrode current collector 21 includes a third surface 21a and a fourth surface 21b. The negative electrode active material layer 22 is disposed on the third surface 21a and the fourth surface 21b of the negative electrode current collector 21. The negative electrode active material layer 22 is provided with a second groove 26 exposing the negative electrode current collector 21. The negative electrode tab 23 is disposed in the second groove 26 and connected to the negative electrode current collector 21. The negative electrode tab 23 is connected to the third surface 21a of the negative electrode current collector 21. A surface of the negative electrode tab 23 is provided with a tab protection tape 17, and a surface of the negative electrode sheet 20 away from the negative electrode tab 23 is provided with the tab protection tape 17. An insulating tape 14 is provided on a region of a surface of the positive electrode sheet 10 opposite to the second groove 26. The insulating tape 14 is also provided on a region opposite to the tab protection tape 17 which is provided on each of regions, corresponding to the second groove 26, of the surface of the positive electrode sheet 10 and the surface of the negative electrode sheet 20 away from the negative electrode tab 23. The insulating tape is provided on each of the region of the surface of the positive electrode sheet opposite to the second groove and the regions opposite to the tab protection tapes provided on the surface of the positive electrode sheet and the surface of the negative electrode sheet facing away from the second groove, so that the risk of the internal short circuit in the secondary battery at high temperatures can be further reduced. Thus, the high-temperature short-circuit pass rate of the secondary battery is increased, thereby improving the reliability of the secondary battery.

In an embodiment of this application, the negative electrode tab includes any one of a nickel tab or a copper-plated nickel tab.

This application imposes no particular limitation on the type of the tab protection tape, and those skilled in the art may select the tab protection tape known in the art based on actual needs, provided that the objective of this application can be achieved.

In an embodiment of this application, the insulating tape includes a substrate and an adhesive layer disposed on one surface of the substrate, where the substrate includes at least one of polyethylene terephthalate, polyimide, or polypropylene. The substrates of the above types have high melting points and good thermal stability, and selecting such substrates is conducive to allowing the insulating tape to have a high melting point. Thus, when the secondary battery is in a high-temperature state, the insulating tape has a low thermal shrinkage rate and good thermal stability and can maintain its integrity as applied, protecting the positive electrode tab with the insulating tape, reducing the probability of contact with the negative electrode sheet, and reducing an area of the internal short circuit in the secondary battery, thereby reducing the probability of the internal short circuit in the secondary battery, and increasing the high-temperature short-circuit pass rate of the secondary battery.

This application imposes no particular limitation on the material type of the adhesive layer, and those skilled in the art may select materials known in the art based on actual needs, provided that the objective of this application can be achieved. For example, the material of the adhesive layer includes at least one of acrylate, rubber, or silicone. Further, the acrylate includes at least one of methyl methacrylate, butyl acrylate, butyl methacrylate, isooctyl acrylate, or octyl methacrylate; and the rubber includes at least one of isoprene or styrene.

In an embodiment of this application, as shown in FIG. 2, along a length direction X of the positive electrode sheet 10, a length L₁₄₁ of the insulating tape 14 provided on the surface of the positive electrode tab is 3 to 4 times a width W₁₃ of the positive electrode tab 13. For example, the length of the insulating tape provided on the surface of the positive electrode tab is 3 times, 3.2 times, 3.4 times, 3.6 times, 3.8 times, 4 times, or any value within a range defined by any two of the above values relative to the width of the positive electrode tab. It should be noted that a width direction of the positive electrode tab is the same as the length direction of the positive electrode sheet, and a length direction of the positive electrode tab is the same as a width direction of the positive electrode sheet. The length of the insulating tape provided on the surface of the positive electrode tab is controlled within the above range, so that when the secondary battery is in the high-temperature state, the insulating tape can cover the surface of the positive electrode tab, protecting the positive electrode tab with the insulating tape, reducing the probability of contact with the negative electrode sheet, and reducing the area of the internal short circuit in the secondary battery, thereby reducing the probability of the internal short circuit in the secondary battery, and increasing the high-temperature short-circuit pass rate of the secondary battery.

In an embodiment of this application, as shown in FIG. 2, along a width direction Y of the positive electrode sheet 10, a width W₁₄₁ of the insulating tape 14 provided on the surface of the positive electrode tab is 0.25 to 0.4 times a width W₁₀ of the positive electrode sheet 10. For example, the width of the insulating tape provided on the surface of the positive electrode tab is 0.25 times, 0.28 times, 0.31 times, 0.34 times, 0.37 times, 0.4 times, or any value within a range defined by any two of the above values relative to the width of the positive electrode sheet. The width of the insulating tape provided on the surface of the positive electrode tab is controlled within the above range, so that when the secondary battery is in the high-temperature state, the insulating tape can cover the surface of the positive electrode tab, protecting the positive electrode tab with the insulating tape, reducing the probability of contact with the negative electrode sheet, and reducing the area of the internal short circuit in the secondary battery, thereby reducing the probability of the internal short circuit in the secondary battery, and increasing the high-temperature short-circuit pass rate of the secondary battery.

In this application, there is no particular limitation on the size specification of the insulating tape provided at positions other than the surface of the positive electrode tab, and those skilled in the art may select based on actual needs, provided that the objective of this application can be achieved.

In an embodiment of this application, along a length direction and width direction of the insulating tape, thermal shrinkage rates of the insulating tape at a temperature of 300° C. are both less than or equal to 1%. For example, along the length direction of the insulating tape, the thermal shrinkage rate at the temperature of 300° C. is 0%, 0.2%, 0.4%, 0.6%, 0.8%, 1%, or any value within a range defined by any two of the above values. For example, along the width direction of the insulating tape, the thermal shrinkage rate of the insulating tape at the temperature of 300° C. is 0%, 0.2%, 0.4%, 0.6%, 0.8%, 1%, or any value within a range defined by any two of the above values. This indicates that the insulating tape has good high-temperature stability at the temperature of 300° C.

In an embodiment of this application, the secondary battery includes a packaging bag. The electrode assembly and the electrolyte are accommodated in the packaging bag. The positive electrode tab and the negative electrode tab extend from the packaging bag. The positive electrode tab and the negative electrode tab are each provided with a sealing adhesive, where the sealing adhesive is sealingly connected to the packaging bag. A melting point of the sealing adhesive is 130° C. to 150° C. For example, the melting point of the sealing adhesive may be 130° C., 135° C., 140° C., 145° C., 150° C., or any value within a range defined by any two of the above values. For example, as shown in FIG. 2, the positive electrode tab 13 is provided with a sealing adhesive 15. The melting point of the sealing adhesive is controlled within the above range, so that when the internal temperature of the secondary battery reaches the melting point range of the sealing adhesive, the sealing adhesive melts to reduce the sealing strength of a connection region between the sealing adhesive and the packaging bag, allowing gas generated at high temperatures to escape from the connection region between the sealing adhesive and the packaging bag, and reducing the accumulation of heat and deformation inside the secondary battery, thereby further improving the reliability of the secondary battery.

In an embodiment of this application, the sealing adhesive includes at least one of polypropylene (PP), polyethylene, polyethylene terephthalate (PET), or polyethylene naphthalate (PEN). This application imposes no particular limitation on the structure of the sealing adhesive, provided that the objective of this application can be achieved. For example, the sealing adhesive may have a single-layer structure or a multi-layer structure, where multi-layer may refer to two layers, three layers, or four layers. For example, the sealing adhesive with the multi-layer structure includes but is not limited to PP/PET/PP and PP/PEN/PP.

In an embodiment of this application, the carbonate includes at least one of ethylene carbonate (EC, also known as vinylene carbonate), propylene carbonate (PC, also known as propyl carbonate), butylene carbonate (BC), dimethyl carbonate (DMC), ethyl methyl carbonate (EMC), diethyl carbonate (DEC), dipropyl carbonate (DPC), methyl propyl carbonate (MPC), ethyl propyl carbonate (EPC), dioctyl carbonate, dipentyl carbonate, ethyl isobutyl carbonate, isopropyl methyl carbonate, di-n-butyl carbonate, diisopropyl carbonate, or propyl carbonate. The carboxylate includes at least one of ethyl acetate, propyl propionate, butyl acetate, ethyl propionate, propyl acetate (EP), or butyl propionate.

In an embodiment of this application, the carbonate includes at least one of ethylene carbonate (EC), propylene carbonate (PC), or diethyl carbonate (DEC). The carboxylate includes at least one of propyl acetate (EP) or propyl propionate. In some embodiments, the carbonate includes EC, PC, and DEC, and the carboxylate includes EP and propyl propionate. 75%≤A+B≤88%, and 2%≤A−B≤5%. For example, A+B may be 75%, 76%, 78%, 80%, 82%, 83%, 84%, 85%, 86%, 87%, 88%, or any value within a range defined by any two of the above values. For example, the value of A−B may be 2%, 2.5%, 3%, 3.5%, 4%, 4.5%, 5%, or any value within a range defined by any two of the above values. Selecting the above types of carbonates and carboxylates and controlling the total mass A+B of the carbonate and the carboxylate and the content difference A−B of the carbonate and the carboxylate within the above ranges can further reduce the gas production amount of the electrolyte at high temperatures, thereby further reducing the probability of explosion due to a large gas production amount inside the secondary battery, and further improving the reliability of the secondary battery.

Further, based on a mass of the electrolyte, a mass percentage of DEC is 5% to 10%, a mass percentage of EC is 10% to 20%, a mass percentage of PC is 20% to 25%, a mass percentage of EP is 10% to 20%, and a mass percentage of propyl propionate is 20% to 25%.

In an embodiment of this application, the electrolyte includes carbonate, carboxylate, and a lithium salt. This application imposes no particular limitation on the content of the lithium salt, provided that the objective of this application can be achieved. In an embodiment of this application, based on the mass of the electrolyte, a mass percentage of the lithium salt is 8% to 15%. For example, the mass percentage of the lithium salt may be 8%, 9%, 10%, 11%, 12%, 13%, 14%, 15%, or any value within a range defined by any two of the above values.

This application imposes no particular limitation on the type of the lithium salt, provided that the objective of this application can be achieved. For example, the lithium salt includes but is not limited to at least one of LiPF₆, LiBF₄, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or LiDFOB.

In an embodiment of this application, the electrolyte includes carbonate, carboxylate, a lithium salt, and an additive. This application imposes no particular limitation on the content of the additive, provided that the objective of this application can be achieved. For example, based on the mass of the electrolyte, a mass percentage of the additive is 4% to 15%. For example, the mass percentage of the additive may be 4%, 6%, 8%, 10%, 12%, 14%, 15%, or any value within a range defined by any two of the above values.

This application imposes no particular limitation on the type of the additive, provided that the objective of this application can be achieved. For example, in some embodiments, the additive includes but is not limited to at least one of succinonitrile, adiponitrile, pimelonitrile, suberonitrile, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,6-dicyano-2-methyl-5-methyl-3-hexene, ethylene glycol dicyanoether, 1,3,6-hexanetricarbonitrile, or 1,2,3-tris(2-cyanooxy)propane. In some other embodiments, the additive includes but is not limited to at least one of succinonitrile, adiponitrile, or 1,3,6-hexanetricarbonitrile.

This application imposes no particular limitation on the type of the positive electrode current collector, provided that the objective of this application can be achieved. For example, the positive electrode current collector may include an aluminum foil, an aluminum alloy foil, and the like.

This application imposes no particular limitation on the positive electrode active material layer, provided that the objective of this application can be achieved. In an embodiment of this application, the positive electrode active material layer includes a positive active material. This application imposes no particular limitation on the type of the positive active material, provided that the objective of this application can be achieved. For example, the positive active material may include at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate. Optionally, the positive electrode active material layer further includes a positive electrode conductive agent and a positive electrode binder. This application imposes no particular limitation on the types of the positive electrode conductive agent and positive electrode binder in the positive electrode active material layer, provided that the objective of this application can be achieved. This application imposes no particular limitation on a mass ratio of the positive active material, positive electrode conductive agent, and positive electrode binder in the positive electrode active material layer, and those skilled in the art may select based on actual needs, provided that the objective of this application can be achieved. For example, the mass ratio of the positive active material, positive electrode conductive agent, and positive electrode binder in the positive electrode active material layer is (97.5-97.9):(0.9-1.7):(1.0-2.0).

This application imposes no particular limitation on the thickness of the positive electrode current collector and the positive electrode active material layer, provided that the objective of this application can be achieved. For example, a thickness of the positive electrode current collector is 5 μm to 20 μm, and a thickness of the positive electrode active material layer is 30 μm to 120 μm.

This application imposes no particular limitation on the negative electrode current collector, provided that the objective of this application can be achieved. For example, the negative electrode current collector may include a copper foil, a copper alloy foil, a nickel foil, a titanium foil, nickel foam, or copper foam.

This application imposes no particular limitation on the negative electrode active material layer, provided that the objective of this application can be achieved. In an embodiment of this application, the negative electrode active material layer includes a negative electrode active material. This application imposes no particular limitation on the type of the negative electrode active material, provided that the objective of this application can be achieved. For example, the negative electrode active material may include at least one of natural graphite, artificial graphite, soft carbon, hard carbon, mesocarbon microbeads, a tin-based material, a silicon-based material, lithium titanate, transition metal nitride, or natural flake graphite. Optionally, the negative electrode active material layer further includes at least one of a negative electrode conductive agent, a thickener, or a negative electrode binder. This application imposes no particular limitation on the types of the negative electrode conductive agent, thickener, and negative electrode binder in the negative electrode active material layer, provided that the objective of this application can be achieved. This application imposes no particular limitation on a mass ratio of the negative electrode active material, negative electrode conductive agent, thickener, and negative electrode binder in the negative electrode active material layer, provided that the objective of this application can be achieved. For example, the mass ratio of the negative electrode active material, negative electrode conductive agent, thickener, and negative electrode binder in the negative electrode active material layer is (97-98):(0-1.5):(0.5-1.5):(1.0-1.9).

This application imposes no particular limitation on the thickness of the negative electrode current collector and the negative electrode active material layer, provided that the objective of this application can be achieved. For example, a thickness of the negative electrode current collector is 5 μm to 20 μm, and a thickness of the negative electrode active material layer is 30 μm to 120 μm.

This application imposes no particular limitation on the separator, provided that the objective of this application can be achieved. For example, the material of the separator may include but is not limited to at least one of polyethylene (PE), polypropylene (PP)-based polyolefin (PO), polyester (for example, a polyethylene terephthalate (PET) film), cellulose, polyimide (PI), polyamide (PA), spandex, or aramid. The type of the separator may include at least one of a woven film, a non-woven film, a microporous film, a composite film, a calendered film, or a spun film.

This application imposes no particular limitation on the packaging bag, and those skilled in the art may select a packaging bag known in the art based on actual needs, provided that the objective of this application can be achieved.

This application imposes no particular limitation on the type of the secondary battery. The secondary battery may include any apparatus undergoing an electrochemical reaction. For example, the secondary battery may include but is not limited to a lithium metal secondary battery, a lithium-ion secondary battery (lithium-ion battery), a sodium-ion secondary battery (sodium-ion battery), a lithium polymer secondary battery, and a lithium-ion polymer secondary battery.

This application imposes no particular limitation on a preparation method of the secondary battery, and preparation methods known in the art may be selected, provided that the objective of this application can be achieved. For example, the preparation method of the secondary battery includes but is not limited to the following steps: stacking the positive electrode sheet, the separator, and the negative electrode sheet in sequence, attaching the insulating tape, and performing operations such as winding and folding as needed to obtain an electrode assembly with a wound structure, placing the electrode assembly into the packaging bag, injecting the electrolyte into the packaging bag, and sealing to obtain the secondary battery; or stacking the positive electrode sheet, the separator, and the negative electrode sheet in sequence, attaching the insulating tape, and fixing four corners of an entire laminated structure to obtain an electrode assembly with a laminated structure, placing the electrode assembly into the packaging bag, injecting the electrolyte into the packaging bag, and sealing to obtain the secondary battery.

A second aspect of this application provides an electronic apparatus including the secondary battery according to any one of the foregoing embodiments. Therefore, the electronic apparatus has good reliability.

The electronic apparatus of this application is not particularly limited and may include but is not limited to the following types: a notebook computer, a pen-input computer, a mobile computer, an e-book reader, a portable phone, a portable fax machine, a portable copier, a portable printer, a head-mounted stereo headphone, a video recorder, a liquid crystal display television, a portable cleaner, a portable CD player, a mini-disc player, a transceiver, an electronic notebook, a calculator, a memory card, a portable recorder, a radio, a backup power source, a motor, an automobile, a motorcycles, an electric bicycle, a bicycle, a lighting fixture, a toy, a gaming console, a clock, an electric tool, a flashlight, a camera, a large household battery, and a lithium-ion capacitor.

### EXAMPLES

Examples and comparative examples are provided below to more specifically illustrate some embodiments of this application. Various tests and evaluations were conducted according to the following methods.

### Test Methods and Devices:

### 1. Test for Thermal Shrinkage Rate:

An insulating tape sample was taken, and the length and width of the sample were measured as A and B. Then, the sample was placed in an oven at 300° C. for 1 h; and the length and width of the sample after baked at a high temperature were measured as A′ and B′.

A thermal shrinkage rate S_{L} (%) in a length direction was equal to [1−(A′/A)]×100%.

A thermal shrinkage rate S_{W} (%) in a width direction was equal to [1−(B′/B)]×100%.

### 2. Test of High-Temperature Short-Circuit Pass Rate:

(1) Pre-treatment: A lithium-ion battery after fully charged at room temperature (25° C.±2° C.) was used as a sample. The steps of fully charging the sample involved charging the sample to 4.5 V at a constant current of 0.2C, and then charging the sample to 0.25C at a constant voltage of 4.5 V.
(2) The sample was placed in a test environment at 55±2° C., a load resistance of 60±20 mΩ was used to short-circuit positive and negative electrodes of the sample, and testing was performed until the voltage was lower than 0.1 V.
(3) The test ended when one of the following conditions was met:
(1) When the voltage of the sample was lower than 0.1 V, and a surface temperature of a main body region dropped to ±10° C. relative to the test environment temperature, then the test was stopped.
(2) If the voltage was unable to drop to 0.1 V, the test was stopped when the surface temperature of the main body region dropped to the test environment temperature.

The main body region referred to a region of an electrode assembly accommodated in the lithium-ion battery where a positive electrode sheet, a negative electrode sheet, and a separator were all in a flat state.

### 3. Measurement Frequency:

Voltage and internal resistance measurements were conducted using a specification of 1 KHz. Measurement was performed once after pre-treatment in step (1) and once after the test in step (3).

Judgment criteria: No explosion occurred, the sample surface temperature did not exceed 150° C., and no fire occurred.

100 lithium-ion batteries from examples and comparative examples were tested. A high-temperature short-circuit pass rate (%) was equal to the number of samples passed the test/100×100%.

### Example 1-1

### <Preparation of Insulating Tape>

An insulating tape included a substrate and an adhesive layer, where the adhesive layer was disposed on one surface of the substrate, the substrate was polyimide, and the material of the adhesive layer was styrene.

A melting point of the insulating tape was 400° C.

### <Preparation of Sealing Adhesive>

A structure of a sealing adhesive was a single-layer structure, where the sealing adhesive included polypropylene and polyethylene, and a mass ratio of polypropylene to polyethylene was 2:1.

A melting point of the sealing adhesive was 140° C.

### <Preparation of Electrolyte>

In a dry argon atmosphere glovebox, diethyl carbonate (DEC), propylene carbonate (PC), ethylene carbonate (EC), propyl acetate (EP), and propyl propionate were mixed to obtain a solvent, then additives succinonitrile, adiponitrile, and 1,3,6-hexanetricarbonitrile as well as a lithium salt LiBF₄ were added into the solvent, dissolved, and mixed well to obtain an electrolyte. Based on a mass of the electrolyte, a mass percentage N_{DEC} of DEC was 8%, a mass percentage N_{PC} of PC was 23%, a mass percentage N_{EC} of EC was 13%, a mass percentage NEP of EP was 18%, a mass percentage N_{PP} of propyl propionate was 23%, a mass percentage of succinonitrile was 2%, a mass percentage of adiponitrile was 3%, a mass percentage of 1,3,6-hexanetricarbonitrile was 3%, and a mass percentage NL of LiBF₄ was 7%.

### <Preparation of Positive Electrode Sheet>

A positive active material LiCoO₂, a positive electrode conductive agent conductive carbon black (Super P), and a positive electrode binder PVDF were mixed at a mass ratio of 97.5:1:1.5, and NMP was added as a solvent. Stirring was performed under a vacuum mixer to obtain a positive electrode slurry with a solid content of 75 wt % and a uniform system. The positive electrode slurry was uniformly applied on one surface of a positive electrode current collector aluminum foil with a thickness of 10 μm, followed by drying at 85° C. to obtain a positive electrode sheet with one surface coated with a positive electrode active material layer (with a thickness of 50 m). Then, the above steps were repeated on another surface of the aluminum foil to obtain a positive electrode sheet with double surfaces coated with the positive electrode active material layer. Then, through processes of cold pressing, cutting, and welding an aluminum tab as a positive electrode tab, a positive electrode sheet with specifications of 96 mm×851 mm was obtained for use. The positive electrode tab is provided with the above sealing adhesive.

### <Preparation of Negative Electrode Sheet>

A negative electrode active material graphite, a negative electrode conductive agent Super P, a thickener carboxymethyl cellulose, and a negative electrode binder styrene-butadiene rubber (SBR) were mixed at a mass ratio of 97.5:1:0.5:1, and deionized water was added as a solvent. Stirring was performed under a vacuum mixer to obtain a negative electrode slurry with a solid content of 50 wt % and a uniform system. The negative electrode slurry was uniformly applied on one surface of a negative electrode current collector copper foil with a thickness of 8 μm, followed by drying at 85° C. to obtain a negative electrode sheet with one surface coated with a negative electrode active material layer (with a thickness of 60 μm). Then, the above steps were repeated on another surface of the copper foil to obtain a negative electrode sheet with double surfaces coated with the negative electrode active material layer. Then, through processes of cold pressing, cutting, and welding a nickel tab as a negative electrode tab, a negative electrode sheet with specifications of 98 mm×867 mm was obtained for use. The negative electrode tab is provided with the above sealing adhesive.

### <Preparation of Separator>

A polyethylene film with a thickness of 15 μm (manufacturer: Hunan Zhongli New Material Co., Ltd.) was used.

### <Preparation of Lithium-Ion Battery>

The prepared negative electrode sheet, separator, and positive electrode sheet were stacked and wound in sequence to obtain an electrode assembly with a wound structure. The electrode assembly was placed in an aluminum-plastic film packaging bag, followed by drying and electrolyte injection. Then, processes such as vacuum packaging, standing, formation, capacity testing, degassing, and trimming to obtain a lithium-ion battery.

As shown in FIG. 1, the insulating tape was attached on the surface of the positive electrode tab, and the insulating tape was attached on a region, corresponding to a first groove, of a surface of the positive electrode sheet away from the positive electrode tab. As shown in FIG. 4, the insulating tape was attached on a region of a surface of the positive electrode sheet opposite to a second groove, and the insulating tape was attached on regions opposite to tab protection tapes provided on the surface of the positive electrode sheet and a surface of the negative electrode sheet facing away from the second groove.

Along a length direction of the positive electrode sheet, a length of the insulating tape provided on the surface of the positive electrode tab was 3.5 times a width of the positive electrode tab, where the width W₁₃ of the positive electrode tab was 6 mm, and the length L₁₄₁ of the insulating tape was 21 mm. Along a width direction of the positive electrode sheet, a width of the insulating tape provided on the surface of the positive electrode tab was 0.3 times a width of the positive electrode sheet, where the width W₁₀ of the positive electrode sheet was 96 mm, and the width W₁₄₁ of the insulating tape was 29 mm.

### Example 1-2

This example was the same as Example 1-1 except that the substrate in <preparation of insulating tape> was adjusted to polyethylene terephthalate such that the melting point of the insulating tape was 250° C.

### Examples 1-3 to 1-11

These examples were the same as Example 1-1 except that the relevant preparation parameters were adjusted according to Table 1.

When the mass percentages of carbonate and carboxylate changed, the mass percentage of the lithium salt changed accordingly, the mass percentage of the additive remained unchanged, and the sum of the mass percentages of carbonate, carboxylate, the lithium salt, and the additive was 100%.

### Examples 2-1 to 2-8

These examples were the same as Example 1-1 except that the relevant preparation parameters were adjusted according to Table 2.

When the times of the length of the insulating tape provided on the surface of the positive electrode tab relative to the width of the positive electrode tab changed, the width of the positive electrode tab remained unchanged, and the length of the insulating tape changed. When the times of the width of the insulating tape provided on the surface of the positive electrode tab relative to the width of the positive electrode sheet changed, the width of the positive electrode sheet remained unchanged, and the width of the insulating tape changed.

### Example 2-9

This example was the same as Example 1-1 except that the mass ratio of polypropylene to polyethylene in <preparation of sealing adhesive> was adjusted to 1:3 such that the melting point of the sealing adhesive was 130° C.

### Example 2-10

This example was the same as Example 1-1 except that the mass ratio of polypropylene to polyethylene in <preparation of sealing adhesive> was adjusted to 4:1 such that the melting point of the sealing adhesive was 150° C.

### Example 2-11

This example was the same as Example 1-1 except that the mass ratio of polypropylene to polyethylene in <preparation of sealing adhesive> was adjusted to 1:4 such that the melting point of the sealing adhesive was 120° C.

### Example 2-12

This example was the same as Example 1-1 except that the mass ratio of polypropylene to polyethylene in <preparation of sealing adhesive> was adjusted to 6:1 such that the melting point of the sealing adhesive was 160° C.

### Comparative Example 1

This comparative example was the same as Example 1-1 except that the substrate in <preparation of insulating tape> was adjusted to a biaxially oriented polypropylene (BOPP) film such that the melting point of the insulating tape was 200° C.

### Comparative Examples 2 to 5

These comparative examples were the same as Example 1-1 except that the relevant preparation parameters were adjusted according to Table 1.

When the mass percentages of carbonate and carboxylate changed, the mass percentage of lithium salt changed accordingly, the mass percentage of additives remained unchanged, and the sum of the mass percentages of carbonate, carboxylate, the lithium salt, and the additive was 100%.

### Comparative Examples 6 and 7

These comparative examples were the same as Comparative Example 1 except that the relevant preparation parameters were adjusted according to Table 1.

When the mass percentages of carbonate and carboxylate changed, the mass percentage of lithium salt changed accordingly, the mass percentage of the additive remained unchanged, and the sum of the mass percentages of carbonate, carboxylate, the lithium salt, and the additive was 100%.

The preparation parameters and performance parameters of examples and comparative examples were shown in Tables 1 and 2.

TABLE 1

| | Melting | | | | | | | | | | High- |
|---|---|---|---|---|---|---|---|---|---|---|---|
| | point of | | | | | | | | | | temperature |
| | insulating | | | Carboxylate | | A + B | | A − B | S_{L} | S_{W} | short-circuit |
| | tape (° C.) | Carbonate type | A (%) | type | B (%) | (%) | A/B | (%) | (%) | (%) | pass rate (%) |
| Example 1-1 | 400 | DEC + PC + EC | 8 + 23 + 13 | EP + PP | 18 + 23 | 85 | 1.07 | 3 | 0.70 | 0.60 | 100 |
| Example 1-2 | 250 | DEC + PC + EC | 8 + 23 + 13 | EP + PP | 18 + 23 | 85 | 1.07 | 3 | 1 | 1 | 75 |
| Example 1-3 | 400 | DEC + PC + EC | 7 + 24.5 + 10 | EP + PP | 17 + 21.5 | 80 | 1.08 | 3 | 0.70 | 0.60 | 100 |
| Example 1-4 | 400 | DEC + PC + EC | 10 + 19.5 +13 | EP + PP | 18 + 21.5 | 82 | 1.08 | 3 | 0.70 | 0.60 | 100 |
| Example 1-5 | 400 | DEC + PC + EC | 9 + 24.5 + 12 | EP + PP | 19 + 23.5 | 88 | 1.07 | 3 | 0.70 | 0.60 | 100 |
| Example 1-6 | 400 | DEC + PC + EC | 7 + 19.5 + 12.5 | EP + PP | 14 + 22 | 75 | 1.08 | 3 | 0.70 | 0.60 | 100 |
| Example 1-7 | 400 | DEC + PC + EC | 10 + 20 + 19.5 | EP + PP | 13.5 + 20 | 83 | 1.48 | 16 | 0.70 | 0.60 | 90 |
| Example 1-8 | 400 | DEC + PC + EC | 8 + 23.5 + 12 | EP + PP | 18 + 23.5 | 85 | 1.05 | 2 | 0.70 | 0.60 | 100 |
| Example 1-9 | 400 | DEC + PC + EC | 8 + 24 + 13 | EP + PP | 17 + 23 | 85 | 1.13 | 5 | 0.70 | 0.60 | 100 |
| Example 1-10 | 400 | DEC+ PC + EC | 8 + 21.5 + 13.5 | EP + PP | 18 + 24 | 85 | 1.02 | 1 | 0.70 | 0.60 | 85 |
| Example 1-11 | 400 | DEC + PC + EC | 9 + 23 + 13.5 | EP + PP | 16.5 + 23 | 85 | 1.15 | 6 | 0.70 | 0.60 | 88 |
| Comparative | 200 | DEC + PC + EC | 8 + 23 + 13 | EP + PP | 18 + 23 | 85 | 1.07 | 3 | 6 | 10 | 50 |
| Example 1 | | | | | | | | | | | |
| Comparative | 400 | DEC+ PC + EC | 6 + 19 + 10 | EP + PP | 15 + 18 | 68 | 1.06 | 2 | 0.70 | 0.60 | 65 |
| Example 2 | | | | | | | | | | | |
| Comparative | 400 | DEC + PC + EC | 8 + 23 + 12 | EP + PP | 22 + 25 | 90 | 0.9 | −4 | 0.70 | 0.60 | 60 |
| Example 3 | | | | | | | | | | | |
| Comparative | 400 | DEC + PC + EC | 6 + 19 + 10 | EP + PP | 19 + 24 | 78 | 0.8 | −8 | 0.70 | 0.60 | 50 |
| Example 4 | | | | | | | | | | | |
| Comparative | 400 | DEC + PC + EC | 15 + 25 + 20 | EP + PP | 10 + 20 | 90 | 2 | −30 | 0.70 | 0.60 | 70 |
| Example 5 | | | | | | | | | | | |
| Comparative | 200 | DEC + PC + EC | 6 + 19 + 10 | EP + PP | 19 + 24 | 68 | 0.8 | −4 | 6 | 10 | 40 |
| Example 6 | | | | | | | | | | | |
| Comparative | 200 | DEC + PC + EC | 15 + 25 + 20 | EP + PP | 10+ 20 | 90 | 2 | −30 | 6 | 10 | 50 |
| Example 7 | | | | | | | | | | | |

From Examples 1-1 to 1-11 and Comparative Examples 1 to 7, it can be seen that the secondary battery in each of the examples of this application is provided with the insulating tape within the melting point range of this application on each of the surface of the positive electrode tab and the region, corresponding to the first groove, of the surface of the positive electrode sheet away from the positive electrode tab, and the total mass A+B of carbonate and carboxylate in the electrolyte and the content ratio A/B of carbonate and carboxylate are within the ranges of this application, so that the insulating tape has relatively low thermal shrinkage rates in the length direction and the width direction, and the high-temperature short-circuit pass rate of the secondary battery is higher, indicating that the secondary battery has higher reliability. In contrast, the secondary battery in each of the comparative examples is provided with the insulating tape on the surface of the positive electrode tab and the region, corresponding to the first groove, of the surface of the positive electrode sheet away from the positive electrode tab, and at least one of the total mass A+B of carbonate and carboxylate in the electrolyte or the content ratio A/B of carbonate and carboxylate is not within the range of this application, so that the high-temperature short-circuit pass rate is lower, indicating that the secondary battery in each of the comparative examples has poor reliability.

The melting point of the insulating tape typically affects the reliability of the secondary battery. From Examples 1-1, Example 1-2, and Comparative Example 1, it can be seen that the secondary battery with the insulating tape having the melting point within the range of this application is used, the insulating tape has relatively low thermal shrinkage rates in the length direction and the width direction, and the high-temperature short-circuit pass rate of the secondary battery is relatively high, indicating that the secondary battery has good reliability.

The total mass A+B of carbonate and carboxylate in the electrolyte, the value of the content ratio A/B of carbonate and carboxylate, and the value of the content difference A−B of carbonate and carboxylate typically affect the reliability of the secondary battery. From Example 1-1, Examples 1-3 to 1-11, and Comparative Examples 2 to 7, it can be seen that the secondary battery with the total mass A+B of carbonate and carboxylate in the electrolyte and the content ratio A/B of carbonate and carboxylate within the ranges of this application is used, the insulating tape has relatively low thermal shrinkage rates in the length direction and the width direction, and the high-temperature short-circuit pass rate of the secondary battery is relatively high, indicating that the secondary battery has good reliability.

TABLE 2

| | Times of length of | Times of width of | | | | |
|---|---|---|---|---|---|---|
| | insulating tape on | insulating tape on | | | | High- |
| | surface of positive | surface of positive | Melting | | | temperature |
| | electrode tab | electrode tab relative | point of | | | short- |
| | relative to width of | to width of positive | sealing | | | circuit |
| | positive electrode | electrode | adhesive | S_{L} | S_{W} | pass rate |
| | tab | sheet | (° C.) | (%) | (%) | (%) |
| Example 1-1 | 3.5 times | 0.3 times | 140 | 0.7 | 0.6 | 100 |
| Example 2-1 | 3 times | 0.3 times | 140 | 0.7 | 0.6 | 95 |
| Example 2-2 | 4 times | 0.3 times | 140 | 0.7 | 0.6 | 100 |
| Example 2-3 | 2 times | 0.3 times | 140 | 0.7 | 0.6 | 90 |
| Example 2-4 | 5 times | 0.3 times | 140 | 0.7 | 0.6 | 100 |
| Example 2-5 | 3.5 times | 0.25 times | 140 | 0.7 | 0.6 | 100 |
| Example 2-6 | 3.5 times | 0.4 times | 140 | 0.7 | 0.6 | 100 |
| Example 2-7 | 3.5 times | 0.15 times | 140 | 0.7 | 0.6 | 85 |
| Example 2-8 | 3.5 times | 0.5 times | 140 | 0.7 | 0.6 | 100 |
| Example 2-9 | 3.5 times | 0.3 times | 130 | 0.7 | 0.6 | 93 |
| Example 2-10 | 3.5 times | 0.3 times | 150 | 0.7 | 0.6 | 92 |
| Example 2-11 | 3.5 times | 0.3 times | 120 | 0.7 | 0.6 | 75 |
| Example 2-12 | 3.5 times | 0.3 times | 160 | 0.7 | 0.6 | 77 |

The times of the length of the insulating tape on the surface of the positive electrode tab relative to the width of the positive electrode tab and the times of the width of the insulating tape relative to the width of the positive electrode sheet typically affect the reliability of the secondary battery. From Example 1-1 and Examples 2-1 to 2-8, it can be seen that the secondary battery where the times of the length of the insulating tape on the surface of the positive electrode tab relative to the width of the positive electrode tab and the times of the width of the insulating tape relative to the width of the positive electrode sheet are within the ranges of this application is used, the insulating tape has relatively low thermal shrinkage rates in the length direction and the width direction, and the high-temperature short-circuit pass rate of the secondary battery is relatively high, indicating that the secondary battery has good reliability. The high-temperature short-circuit pass rate of the secondary battery of Example 2-4 is the same as those of Examples 1-1, 2-1, and 2-2, but the insulating tape is relatively long, which affects the production cost of the secondary battery and leads to capacity loss due to the increased volume of the secondary battery, thereby affecting the capacity of the secondary battery. The high-temperature short-circuit pass rate of the secondary battery of Example 2-8 is the same as those of Examples 1-1, 2-5, and 2-6, but the insulating tape is relatively wide, which affects the production cost of the secondary battery and leads to capacity loss due to the increased volume of the secondary battery, thereby affecting the capacity of the secondary battery.

The melting point of the sealing adhesive typically affects the reliability of the secondary battery. From Example 1-1 and Examples 2-9 to 2-12, it can be seen that the secondary battery with the sealing adhesive having the melting point within the range of this application is used, the insulating tape has relatively low thermal shrinkage rates in the length direction and the width direction, and the high-temperature short-circuit pass rate of the secondary battery is relatively high, indicating that the secondary battery has good reliability. As compared with Examples 1-1, 2-10, and 2-11, the secondary battery with a sealing adhesive having a melting point of 120° C. is used in Example 2-11, and the melting point of the sealing adhesive is relatively low, resulting in relatively poor sealing performance and a relatively high probability of electrolyte leakage in the secondary battery. Therefore, the high-temperature short-circuit pass rate is lower than those of Examples 1-1, 2-10, and 2-11. As compared with Examples 1-1, 2-10, and 2-11, the secondary battery with a sealing adhesive having a melting point of 160° C. is used in Example 2-12, and the melting point of the sealing adhesive is relatively high. The gas generated inside the secondary battery escapes the packaging bag at a relatively slow speed when the internal temperature rises, leading to relatively slow heat dissipation of the secondary battery and an increased probability of thermal runaway. Therefore, the high-temperature short-circuit pass rate is lower than those of Examples 1-1, 2-10, and 2-11.

It should be noted that relational terms such as first and second herein are only used to distinguish one entity or operation from another entity or operation region and do not necessarily require or imply any such actual relationship or order between these entities or operations. In addition, the terms “include”, “contain”, or any other variations thereof are intended to cover a non-exclusive inclusion, so that a process, a method, an item, or a device including a series of elements not only includes those elements but also includes other elements that are not expressly listed, or further includes elements inherent to such process, method, item, or device.

Various embodiments in this specification are described in related manners, provided that same or similar parts of various embodiments are referred to each other. Each embodiment focuses on the difference from another embodiment.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising an electrode assembly and an electrolyte; wherein the electrode assembly comprises a positive electrode sheet, a negative electrode sheet, and a separator disposed between the positive electrode sheet and the negative electrode sheet;
the positive electrode sheet comprises a positive electrode current collector, a positive electrode active material layer, and a positive electrode tab; wherein the positive electrode active material layer is disposed on at least one surface of the positive electrode current collector; the positive electrode active material layer is provided with a first groove exposing the positive electrode current collector; the positive electrode tab is disposed in the first groove and connected to the positive electrode current collector; an insulating tape is provided on a surface of the positive electrode tab, and the insulating tape is further disposed on a region of a surface of the positive electrode sheet facing away from the positive electrode tab, corresponding to the first groove;
a melting point of the insulating tape is 250° C. to 450° C.;
the electrolyte comprises carbonate and carboxylate; and
based on a mass of the electrolyte, a mass percentage of the carbonate is A and a mass percentage of the carboxylate is B, wherein 75%≤A+B≤88% and 1<A/B.

2. The secondary battery according to claim 1, wherein the melting point of the insulating tape is 250° C. to 400° C.

3. The secondary battery according to claim 1, wherein the negative electrode sheet comprises a negative electrode current collector, a negative electrode active material layer, and a negative electrode tab; the negative electrode active material layer is disposed on at least one surface of the negative electrode current collector; the negative electrode active material layer is provided with a second groove exposing the negative electrode current collector; the negative electrode tab is disposed in the second groove and connected to the negative electrode current collector; a tab protection tape is provided on an area of a surface of the negative electrode sheet facing away from the negative electrode tab corresponding to the second groove; and
the insulating tape is further provided on each of a region of the surface of the positive electrode sheet opposite to the second groove and a region of the surface of the positive electrode sheet opposite to the tab protection tape.

4. The secondary battery according to claim 1, wherein the insulating tape comprises a substrate and an adhesive layer disposed on one surface of the substrate, wherein
the substrate comprises at least one of polyethylene terephthalate, polyethylene, polytetrafluoroethylene, polyvinyl chloride, polyimide, or polypropylene.

5. The secondary battery according to claim 1, wherein along a length direction of the positive electrode sheet, a length of the insulating tape provided on the surface of the positive electrode tab is 3 to 4 times a width of the positive electrode tab; and
along a width direction of the positive electrode sheet, a width of the insulating tape provided on the surface of the positive electrode tab is 0.25 to 0.4 times a width of the positive electrode sheet.

6. The secondary battery according to claim 2, wherein along a length direction of the positive electrode sheet, a length of the insulating tape provided on the surface of the positive electrode tab is 3 to 4 times a width of the positive electrode tab; and
along a width direction of the positive electrode sheet, a width of the insulating tape provided on the surface of the positive electrode tab is 0.25 to 0.4 times a width of the positive electrode sheet.

7. The secondary battery according to claim 3, wherein along a length direction of the positive electrode sheet, a length of the insulating tape provided on the surface of the positive electrode tab is 3 to 4 times a width of the positive electrode tab; and
along a width direction of the positive electrode sheet, a width of the insulating tape provided on the surface of the positive electrode tab is 0.25 to 0.4 times a width of the positive electrode sheet.

8. The secondary battery according to claim 1, wherein a thermal shrinkage rate of the insulating tape along a length direction of the insulating tape and a thermal shrinkage rate of the insulating tape along a width direction of the insulating tape, at a temperature of 300° C., are both less than or equal to 1%.

9. The secondary battery according to claim 2, wherein a thermal shrinkage rate of the insulating tape along a length direction of the insulating tape and a thermal shrinkage rate of the insulating tape along a width direction of the insulating tape, at a temperature of 300° C., are both less than or equal to 1%.

10. The secondary battery according to claim 3, wherein a thermal shrinkage rate of the insulating tape along a length direction of the insulating tape and a thermal shrinkage rate of the insulating tape along a width direction of the insulating tape, at a temperature of 300° C., are both less than or equal to 1%.

11. The secondary battery according to claim 1, wherein the carbonate comprises at least one of ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and
the carboxylate comprises at least one of ethyl acetate, propyl propionate, butyl acetate, ethyl propionate, propyl acetate, or butyl propionate.

12. The secondary battery according to claim 2, wherein the carbonate comprises at least one of ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and
the carboxylate comprises at least one of ethyl acetate, propyl propionate, butyl acetate, ethyl propionate, propyl acetate, or butyl propionate.

13. The secondary battery according to claim 3, wherein the carbonate comprises at least one of ethylene carbonate, propylene carbonate, butylene carbonate, dimethyl carbonate, ethyl methyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and
the carboxylate comprises at least one of ethyl acetate, propyl propionate, butyl acetate, ethyl propionate, propyl acetate, or butyl propionate.

14. The secondary battery according to claim 11, wherein the carbonate comprises at least one of ethylene carbonate, propylene carbonate, or diethyl carbonate; the carboxylate comprises at least one of propyl acetate or propyl propionate; and
2%≤A−B≤5%.

15. The secondary battery according to claim 12, wherein the carbonate comprises at least one of ethylene carbonate, propylene carbonate, or diethyl carbonate; the carboxylate comprises at least one of propyl acetate or propyl propionate; and
2%≤A−B≤5%.

16. The secondary battery according to claim 13, wherein the carbonate comprises at least one of ethylene carbonate, propylene carbonate, or diethyl carbonate; the carboxylate comprises at least one of propyl acetate or propyl propionate; and
2%≤A−B≤5%.

17. The secondary battery according to claim 1, wherein the secondary battery comprises a packaging bag; the electrode assembly and the electrolyte are accommodated in the packaging bag; the positive electrode tab and the negative electrode tab extend out from the packaging bag; the positive electrode tab and the negative electrode tab are each provided with a sealing adhesive, the sealing adhesive being sealingly connected to the packaging bag; and
a melting point of the sealing adhesive is 130° C. to 150° C.

18. The secondary battery according to claim 2, wherein the secondary battery comprises a packaging bag; the electrode assembly and the electrolyte are accommodated in the packaging bag; the positive electrode tab and the negative electrode tab extend out from the packaging bag; the positive electrode tab and the negative electrode tab are each provided with a sealing adhesive, the sealing adhesive being sealingly connected to the packaging bag; and
a melting point of the sealing adhesive is 130° C. to 150° C.

19. The secondary battery according to claim 17, wherein the sealing adhesive comprises at least one of polypropylene, polyethylene, polyethylene terephthalate, or polyethylene naphthalate.

20. An electronic apparatus, comprising a secondary battery, wherein the secondary battery comprises an electrode assembly and an electrolyte; wherein the electrode assembly comprises a positive electrode sheet, a negative electrode sheet, and a separator disposed between the positive electrode sheet and the negative electrode sheet;
the positive electrode sheet comprises a positive electrode current collector, a positive electrode active material layer, and a positive electrode tab; wherein the positive electrode active material layer is disposed on at least one surface of the positive electrode current collector; the positive electrode active material layer is provided with a first groove exposing the positive electrode current collector; the positive electrode tab is disposed in the first groove and connected to the positive electrode current collector; an insulating tape is provided on a surface of the positive electrode tab and the insulating tape is further disposed on a region of a surface of the positive electrode sheet facing away from the positive electrode tab, corresponding to the first groove;
a melting point of the insulating tape is 250° C. to 450° C.;
the electrolyte comprises carbonate and carboxylate; and
based on a mass of the electrolyte, a mass percentage of the carbonate is A and a mass percentage of the carboxylate is B, wherein 75%≤A+B≤88% and 1<A/B.
